(19) United States
(12) Patent Application Publication
(10) Pub. No.: US 2018/0227201 A1
(43) Pub. Date: Aug. 9, 2018

(54) SYSTEM, METHOD AND COMPUTER PROGRAM PRODUCT FOR TEST-DRIVEN NODE SELECTION FOR A DISTRIBUTED SYSTEM

(71) Applicant: International Business Machines Corporation, Armonk, NY (US)

(72) Inventor: Kirk J. Krauss, SAN JOSE, CA (US)

(73) Assignee: International Business Machines Corporation

(21) Appl. No.: 15/427,812

(22) Filed: Feb. 8, 2017

(51) Int. Cl. H04L 12/26; H04L 12/911

(52) U.S. Cl. CPC H04L 43/0805; H04L 47/70; H04L 43/50

(57) ABSTRACT

A resource management method, system, and computer program product in a distributed computing environment that, for each distributable component, determines a characteristic maximum memory requirement by profiling resource utilization targeting the component's range of expected use cases. A component is instantiated on a node whose available non-swap virtual memory is nearest to, but greater than or equal to, the component's characteristic maximum memory requirement as determined via the profiling.

### BACKGROUND

The present invention relates generally to a resource management method applicable to executable software components operable in a distributed computing environment or a cloud computing environment. More particularly, but not by way of limitation, the present invention relates to a system, method, and computer program product that, for each distributable component, determines a characteristic maximum memory requirement by advance resource usage profiling targeting the component's range of expected use cases. A component is instantiated on a computer, or node, whose available non-swap virtual memory is nearest to, but greater than or equal to, the component's characteristic maximum virtual memory requirement.

To get the most out of distributed systems, each node of the system is typically used to its maximum potential. However, overloading a node, particularly by overcommitting virtual memory, often occurs. Any node that begins swapping out virtual memory pages to support its workload can impede the performance of the entire distributed system.

The utilization of virtual memory or other resources by a distributable component can vary according to conditions that can include the context in which the component is invoked, the nature of the invoking routine, the workload being processed, and other conditions that may apply at component deployment time. Deploying a component with no consideration of its deployment-time conditions can result in a need to later migrate the component between nodes, in order to reduce resource overcommitment that occurs after the initial deployment. Migration of a component operating in a live context often requires swapping out virtual memory pages associated with the component on one node and swapping them in on another node, as execution involving the component is in progress. Component migration, like any situation involving virtual memory page swapping, can impede the performance of the entire distributed system, at least until the migration is complete.

Some cloud computing systems and other distributed systems are arranged to save power and costs by powering on only as many nodes as are necessary for a workload at any given time. Such systems can best meet their power and cost savings goals by making the most effective possible use of the resources that are available among a given set of powered-on nodes. The most effective possible use, in these systems, typically is the use that best exploits the resources of the powered-on nodes without either compromising the performance of the cloud or distributed system or requiring more nodes to be powered on.

Conventionally, the selection of a node on which to deploy a particular component has generated a lot of interest. Some conventional techniques consider employing performance profiling as guidance for node selection. Other conventional techniques, typically those specific to one particular domain or another, consider employing simulation or hardware or software modeling techniques to determine optimal node selection.

However, there is a need in the art for the selection of an optimal node based on characteristic requirements for virtualized resources such as memory.

### SUMMARY

In an exemplary embodiment, the present invention can provide a computer-implemented resource management method in a distributed computing environment, the method including for each of a plurality of computers, determining an available capacity associated with a resource, selecting a computer, from the plurality of computers, having an available capacity associated with the resource that is greater than or equal to a characteristic maximum requirement of a component for the resource, and deploying the component on the selected computer. One or more other exemplary embodiments include a computer program product and a system.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings. Rather, the invention is capable of embodiments in addition to those described and of being practiced and carried out in various ways that should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a resource management method 100 according to an embodiment of the present invention;

FIG. 2 depicts a cloud-computing node 10 according to an embodiment of the present invention;

FIG. 3 depicts a cloud-computing environment 50 according to an embodiment of the present invention;

FIG. 4 depicts abstraction model layers according to an embodiment of the present invention; and

FIG. 5 depicts call graphs representing control flow into and through a module that is deployable in various contexts on various nodes according to an embodiment of the present invention.

### DETAILED DESCRIPTION

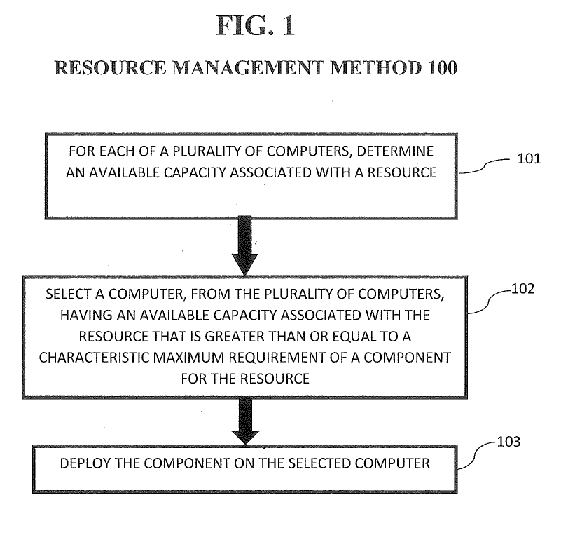

The invention will now be described with reference to FIGS. 1-5, in which like reference numerals refer to like parts throughout. It is emphasized that, according to common practice, the various features of the drawings are not necessarily to scale. On the contrary, the dimensions of the various features can be arbitrarily expanded or reduced for clarity.

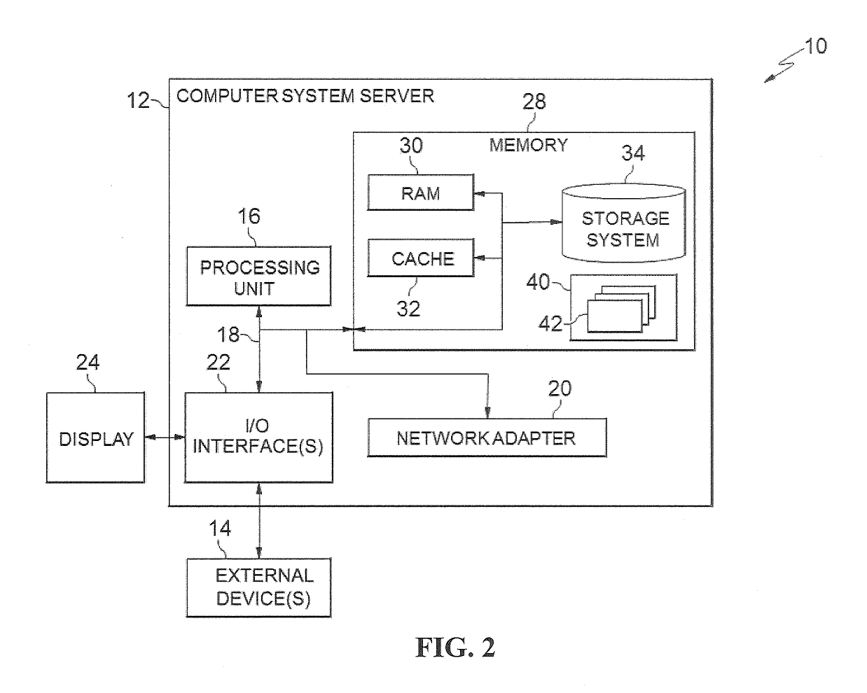

By way of introduction of the example depicted in FIG. 1, an embodiment of a resource management method 100 according to the present invention can include various steps for instantiating a software component on a node whose available non-swap virtual memory is nearest to, but greater than or equal to, the component's characteristic maximum virtual memory requirement. By way of introduction of the example depicted in FIG. 2, one or more computers of a computer system 12 according to an embodiment of the present invention can include a memory 28 having instructions stored in a storage system to performing the steps of FIG. 1.

It is noted that the “available capacity” referred to herein is the amount of virtual memory or some other resource that may be allocated without triggering a paging or swapping operation or some other operation related to resource overcommitment. Resource overcommitment refers to the assignment of a virtual resource in an amount greater than the physical amount available. Overcommitment of virtual memory can result in paging or swapping operations in which a disk or other media serves as a backing store, so that actual usage of the memory beyond the amount available results in reads and writes to a disk or other media. In an overcommitment scenario, reads and writes to a disk or other media typically incur a significant performance penalty, because accessing the disk or other media typically requires much more time than accessing physical memory. Virtual memory that is accessible by a node without requiring access to the disk or other media is referred to herein as available non-swap virtual memory.

It is also noted that the “component” referred to herein is a software component discretely operable on a distributed system and can include a virtual machine, a set of virtual machines, a hypervisor, an operating system, an operating system service or device driver, an executable program, a module or library loadable by or linked with an executable program, an object, a set of objects, a code sequence, a function, a method, a procedure, a thread, a fiber, a dynamic-link library (“DLL”), a shared object (“SO”), or any information, having an executable aspect, that may be discretely instantiated in a distributed context. In the examples provided herein, unless otherwise indicated, a component may be considered to be a module that may be dynamically loaded by an executable program operable on a distributed system. The examples provided herein are not intended to limit the scope of the invention.

Referring now generally to the embodiments of the invention, distributable components are subject to resource utilization profiling in advance of deployment to determine their range of requirements for one or more virtualized resources. Profiling utilization of the virtualized resource can include running a series of advance tests in which the amount of a resource (e.g., virtual memory) used by a distributable component is monitored and recorded. Profiling utilization of the virtualized resource also can include use of a profiling tool (e.g. a memory profiler) which may run, without operator initiation or intervention, to monitor and record resource utilization for the distributable component. Profiling utilization of the virtualized resource also can include use of dynamic analysis implemented via interception of entry points to the distributable component, interception of resource commitment (e.g. associated with memory allocations and deallocations) by the distributable component, or other applicable interception or “hook” functionality or the like. Profiling utilization of the virtualized resource also can include static analysis (e.g. flow control analysis oriented toward arriving at a determination or estimate of memory utilization by the component).

Profiling utilization of the virtualized resource can include profiling of one component or many components at once. For example, a virtual machine may serve as an execution environment for an executable program that dynamically loads various modules in which various functions execute under various conditions. In embodiments, the entire virtual machine, and all executable programs running on it, may be profiled. In embodiments, an executable program, and all of the modules it loads during a test run, may be profiled. In embodiments, a module and all of the functions invoked as it may run, may be profiled. In embodiments, functions may be profiled in specific execution contexts or conditions. An embodiment may perform some or all of the profiling described in these examples, as needed to determine or estimate resource utilization sufficiently to affect component placement among a group of nodes.

Results of profiling performed for one instance of a component may be applied to other instances of the component. For instance, a virtual machine may serve as an execution environment for an executable program that dynamically loads a module that includes a function that may be observed to allocate a relatively significant amount of heap memory, for example a gigabyte, possibly over the course of a number of invocations of that function, performed under certain workload conditions tested or analyzed as the profiler tracks resource utilization. The profiler, or code that analyzes the profiler's findings, can associate the function, module, executable program, virtual machine, or any or all of these components with the gigabyte of virtual memory committed in the tested or analyzed workload conditions. In some embodiments, “clone” instances of the virtual machine may be derived from the virtual machine and subjected to similar workload conditions. In some embodiments, the executable program may be subjected to similar workload conditions, as it executes on any machine, virtual or otherwise. In some embodiments, the module may be loaded by any executable program and subjected to similar workload conditions. In some embodiments, the function may be dynamically incorporated into any module and subjected to similar workload conditions. An embodiment may associate any or all of the components described in these examples with one or more conditions in which a characteristic maximum virtual memory utilization may be determined or estimated based on the results of profiling. The conditions may be any conditions applicable at component deployment time and are not limited to the workload conditions of this example.

Determinations or estimates of utilization of a virtualized resource by a component can be recorded via one or more lists, graphs, or other data structures. For a component, embodiments can determine a resource utilization level above which a probability of reaching that level, during a run, is less than a predetermined threshold probability. In some embodiments, the probability of reaching that level may be determined based on probabilistic or statistical calculations or methods. In other embodiments, the probability of reaching that level may be determined based on a heuristic, machine learning, fuzzy logic, or comparison of numbers such as units of resource utilization (e.g., in bytes, kilobytes, megabytes, gigabytes, etc.), or by other means. Similarly, the predetermined threshold probability may be a number, such as a similar unit of resource utilization, that may be compared.

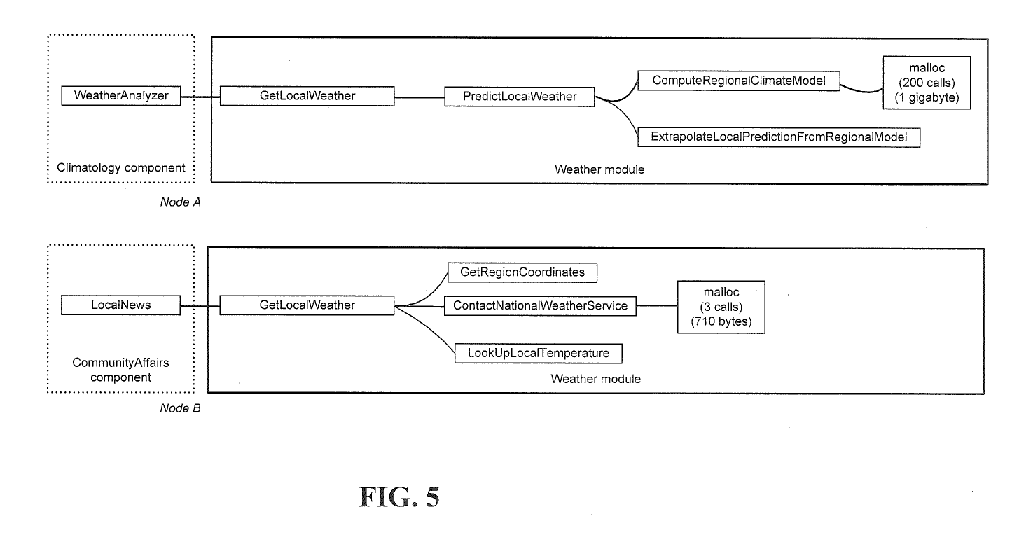

Profiling utilization of the virtualized resource can generate a single resource usage determination or estimate. Profiling utilization of the virtualized resource also can generate a range of resource usage determinations or estimates applicable to a range of various conditions, such as invocation of functionality within the distributable component by other components of a first class as opposed to invocation of that functionality by other components of a second class. FIG. 5 illustrates an example of call graphs representing control flow into and through a module that is deployable in various conditions; these example call graphs reveal a wide variability in memory use that can apply depending on those various conditions. A data structure, or set of data structures, can store the profiling results, and in some embodiments can associate the profiling results with one or more conditions that can be checked when the component is deployed on a node during a production run involving the component in the distributed context. If call graphs are used in an embodiment, those call graphs may be memory resident only, and as they are used in an automated context to select a node for component deployment, no call graph need necessarily be displayed via any user interface in embodiments. A memory-resident list or other data structure may also serve the same purpose in other embodiments. For each advance test or analysis used in profiling, a characteristic maximum resource utilization is determined, and the result is stored as an element in a list, graph, or other data structure that may be stored in a database, on the cloud, or in memory local to a process embodying all or part of the invention.

The list, graph, or other data structure is analyzed, prior to deployment of the component on a node, to determine a resource utilization level above which the probably of reaching that level, during a run, is less than a predetermined threshold probability. The resource utilization level is recorded as the component's characteristic maximum utilization level for that resource. In some embodiments, more than one of the component's characteristic maximum utilization levels for that resource may be stored, in association with conditions detected during profiling. In those embodiments, a deployment-time check for similar conditions can provide a means of selecting a particular one of the component's characteristic maximum utilization levels for the resource, for use in selecting an appropriate node on which to deploy the component. If the resource under test or analysis is virtual memory, then one or more memory utilization levels, associated respectively with one or more various deployment-time conditions, are recorded as the component's characteristic maximum virtual memory applicable in those respective deployment-time conditions.

The example call graphs of FIG. 5 illustrate the significance of associating deployment-time conditions with anticipated memory use associated with those conditions. As shown in FIG. 5, depending on the context, e.g. the parameters passed between components, invoking a Weather module via its GetLocalWeather( ) entry point can cause different functionality to be performed from run to run, and from node to node, depending on the context. This widely variable functionality can result in widely variable memory use.

As shown in FIG. 5, the call graph for Node A represents a use case for the GetLocalWeather( ) function in which that function, along with descendent functions invoked by it in the Weather module, is called to arrange a weather prediction based on a climate model that requires a relatively large amount of memory to load, store, and update as a prediction function in the Weather module works with that climate model. The call graph for Node B represents a use case, also for the GetLocalWeather( ) function, that takes a different path, avoiding the need to load the climate model, thus requiring only a relatively very small memory use.

All nodes are subject to monitoring to determine the amount of virtual memory that may be allocated without triggering a paging or swapping operation. This monitoring can determine the available non-swap virtual memory for each node.

When a component is ready to be deployed, the node with the nearest amount (closest amount) of available non-swap virtual memory that is greater than or equal to the component's characteristic maximum memory, is selected. The component is deployed onto the selected node. For example, if the component's characteristic maximum memory is two units of memory, and if a first node has four units of available non-swap virtual memory, a second node has five units of available non-swap virtual memory, and a third node has one unit of available non-swap virtual memory, then the first node is selected. In this example, the units may be bytes, kilobytes, megabytes, gigabytes, or any other units reasonably applicable for determining both the component's characteristic maximum virtual memory and the nodes' available non-swap virtual memory.

Although it is preferred that a node with an amount of available non-swap virtual memory nearest to the component's characteristic maximum virtual memory is selected for optimal usage of resources local to nodes, any node having available non-swap virtual memory greater than the component's characteristic maximum memory can be selected.

Besides memory, advance resource utilization profiling can target allocation of other virtualized resources, and the invention could work similarly. The invention also is applicable to scenarios in which memory overcommitment is, or may likely become, unavoidable because of a scarcity of a resource throughout the distributed system. In those scenarios, node selection can include selection of a node whose resource availability is greater than, equal to, or least significantly less than a characteristic maximum requirement of the component for the resource. Also, in those scenarios, the maximum requirement may be a maximum or threshold applicable to some deployment-time conditions and not to others.

Testing or analyzing for resource requirements can be performed based on watchdog software, a memory (or other) profiler, performance counters, coded hooks, component instrumentation, static analysis, flow control analysis, or any number of other means. Testing or analyzing can be performed, and characteristic maximum virtual memory requirements can be updated, either on a regular basis or as triggered by software or system modifications.

Referring now to FIG. 1, in step 101, for each of a plurality of computers, an available capacity associated with a resource is determined. The resource can include, for example, a virtual memory, a virtual disk, a virtual network device or network bandwidth, a virtual storage device, or other virtualized hardware or capability sharable by components.

In step 102, a computer is selected, from the plurality of computers, having an available capacity associated with the resource that is (most nearly) greater than or equal to a component's characteristic maximum requirement for the resource. A component's characteristic maximum virtual memory requirement is determined based on the component's maximum virtual memory utilization determined or estimated via profiling performed in advance.

In step 102, the determination of the component's characteristic maximum virtual memory requirement can include storing the component's maximum virtual memory utilization for each of the series of tests or analyses in a list, graph, or other data structure, and analyzing the list, graph, or other data structure to determine a virtual memory utilization level above which a probability of reaching that level, during a run, is less than a predetermined threshold probability.

In step 103, the component is deployed on the selected computer of the plurality of computers.

By at least steps 101-103, the invention involves an analysis of software components, either executable programs or their constituent modules or other components, to determine their characteristic requirements for a resource, most typically virtual memory. When the characteristic requirements have been determined via advance testing or other advance analysis or monitoring of the executable program or its components, the components can be deployed onto the nodes of a distributed system that best fit the components' characteristic requirements. The invention considers the best fit to be the node whose available capacity associated with a resource such as virtual memory (i.e., virtual memory not currently utilized by a process that is already running) that is most nearly greater than or equal to the characteristic requirements. A best fit involving a resource of another type, such as a best-fit allocation of network bandwidth, is similarly made possible via the invention. If the estimated best-fit placement is sufficiently accurate, then resource utilization will approach but not exceed the real resource availability on the node where the executable program or its components are initially placed. Resource overcommitment will be unlikely, and migration of the executable program or its components between nodes to accommodate resource utilization need not be arranged. In embodiments where power and cost savings involves powering on only as many nodes as are necessary for a workload, the workload will be handled by components deployed onto powered-on nodes in accordance with resource utilization verified by advance testing or analysis of those components, thus utilizing the resources available among the powered-on nodes in light of automated resource utilization determination performed on a component-by-component basis, avoiding the need to power on more nodes unnecessarily.

Exemplary Aspects, using a Cloud Computing Environment

Although this detailed description includes an exemplary embodiment of the present invention in a cloud computing environment, it is to be understood that implementation of the teachings recited herein are not limited to such a cloud computing environment. Rather, embodiments of the present invention are capable of being implemented in conjunction with any other type of distributed computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client circuits through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (Paas): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

Referring now to FIG. 2, a schematic of an example of a cloud computing node is shown. Cloud computing node 10 is only one example of a suitable node and is not intended to suggest any limitation as to the scope of use or functionality of embodiments of the invention described herein. Regardless, cloud computing node 10 is capable of being implemented and/or performing any of the functionality set forth herein.

Although cloud computing node 10 is depicted as a computer system/server 12, it is understood to be operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, hand-held or laptop circuits, multiprocessor systems, microprocessor-based systems, set-top boxes, programmable consumer electronics, network PCs, minicomputer systems, mainframe computer systems, and distributed cloud computing environments that include any of the above systems or circuits, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing circuits that are linked through a communications network. In a distributed cloud computing environment, program modules may be located in both local and remote computer system storage media including memory storage circuits.

Referring now to FIG. 2, a computer system/server 12 is shown in the form of a general-purpose computing circuit. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media may be any available media that is accessible by computer system/server 12, and it includes both volatile and non-volatile media, and removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive or flash drive (e.g., a USB “thumb” drive), and an optical disk drive for reading from or writing to a removable, non-volatile optical disk such as a CD-ROM, DVD-ROM or other optical media can be provided. In such instances, each can be connected to bus 18 by one or more interfaces. As will be further described below, memory 28 may include a computer program product storing one or program modules 42 comprising computer readable instructions configured to carry out one or more features of the present invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may be adapted for implementation in a networking environment. In some embodiments, program modules 42 are adapted to generally carry out one or more functions and/or methodologies of the present invention.

Computer system/server 12 may also communicate with one or more external devices 14 such as a keyboard, a pointing device, other peripherals, such as display 24, etc., and one or more components that facilitate interaction with computer system/server 12. Such communication can occur via Input/Output (I/O) interface 22, and/or any circuits (e.g., network card, modern, etc.) that enable computer system/server 12 to communicate with one or more other computing circuits. For example, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

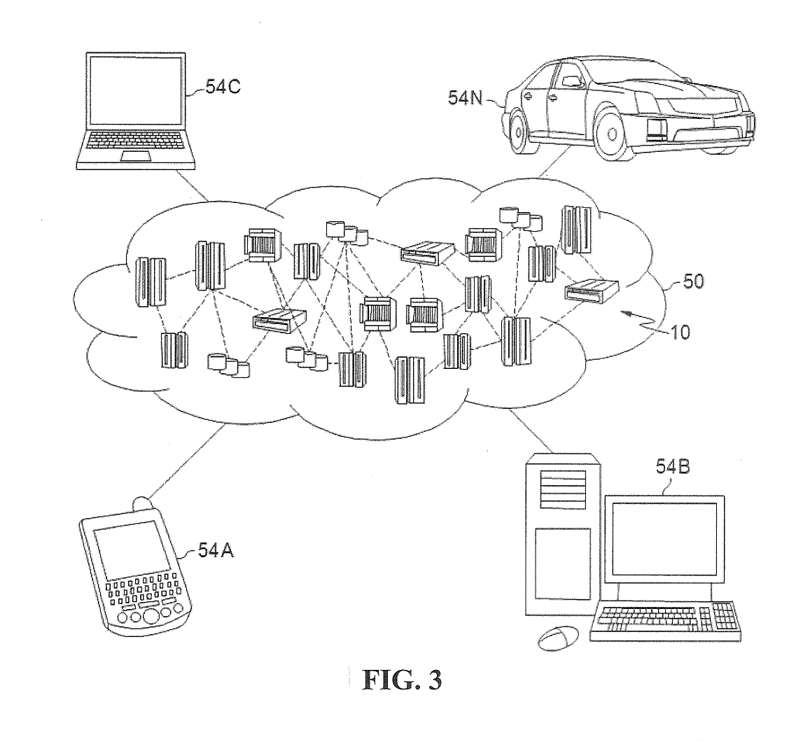

Referring now to FIG. 3, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources attached to a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

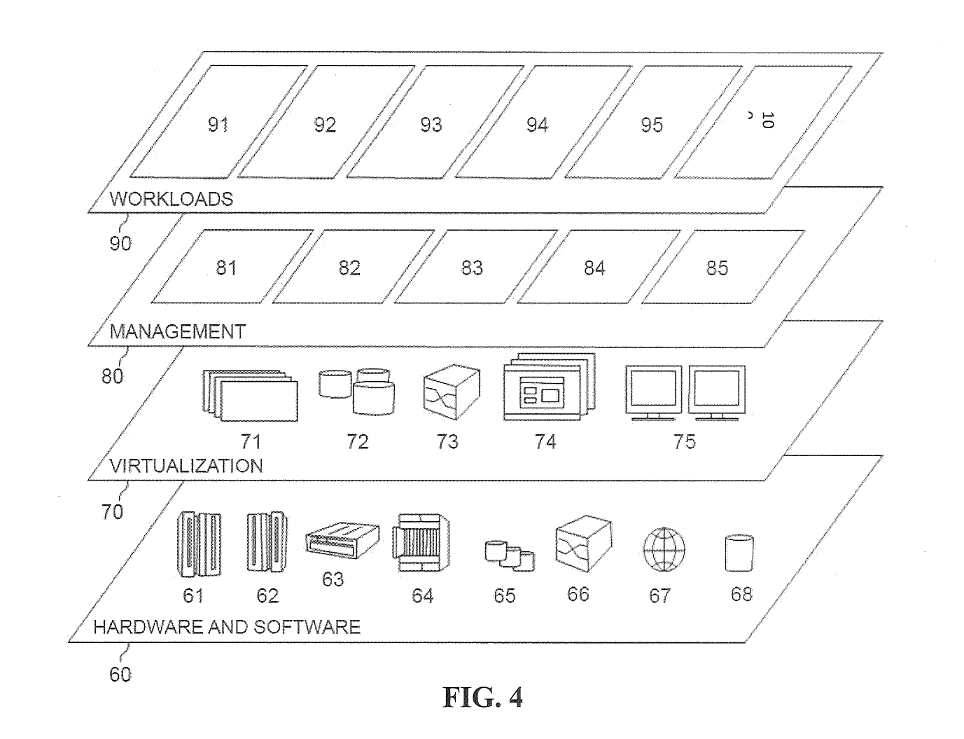

Referring now to FIG. 4, an exemplary set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development lifecycle management 92; virtual classroom education delivery 93; data analytics processing 94; transaction processing 95; and resource management method 100 in accordance with the present invention.

The present invention may be embodied as a system, a method, and/or a computer program product at any reasonable level of integration with workloads layer 90, management layer 80, virtualization layer 70, hardware and software layer 60, and cloud computing environment 50. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), a Storage Area Network (SAN), a Network Attached Storage (NAS) device, a Redundant Array of Independent Discs (RAID), an erasable programmable read-only memory (EPROM or Flash memory), a static random access memory (SRAM), a portable compact disc read-only memory (CD-ROM), a digital versatile disk (DVD), a memory stick, a USB “thumb” drive, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source code or object code written in any combination of one or more programming languages, including an object oriented programming language such as Smalltalk, C++, or the like, or procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented resource management method in a distributed computing environment, the method comprising:
for each of a plurality of computers, determining an available capacity associated with a resource;
selecting a computer, from the plurality of computers, having an available capacity associated with the resource that is greater than or equal to a characteristic maximum requirement of a component determined by profiling utilization of the resource; and
deploying the component on the selected computer.

2. The computer-implemented method of claim 1, wherein the resource includes a virtual memory.

3. The computer-implemented method of claim 1, wherein the available capacity comprises an amount of the resource that can be committed without triggering an operation associated with overcommitting the resource.

4. The computer-implemented method of claim 1, wherein the selecting selects the computer with the resource that is most near to the characteristic maximum requirement of the component for the resource.

5. The computer-implemented method of claim 2, wherein the characteristic maximum virtual memory requirement of the component is determined based on a maximum memory utilization associated with the component for each of a series of tests performed in advance of the deploying.

6. The computer-implemented method of claim 1, wherein the determining the characteristic maximum requirement of the component for the resource comprises:
profiling utilization of the resource in advance of the deploying;
as a result of the profiling, storing in one or more data structures a utilization, associated with the component, of the resource; and
analyzing the one or more data structures to determine a resource utilization level above which a probability of reaching that level, during a run, is less than a predetermined threshold probability.

7. The computer-implemented method of claim 1, embodied in a cloud-computing environment.

8. A computer program product for resource management, the computer program product comprising a computer-readable storage medium having program instructions embodied therewith, the program instructions executable by a computer to cause the computer to perform:
for each of a plurality of computers, determining an available capacity associated with a resource;
selecting a computer, from the plurality of computers, having an available capacity associated with the resource that is greater than or equal to a characteristic maximum requirement of a component determined by profiling utilization of the resource; and
deploying the component on the selected computer.

9. The computer program product of claim 8, wherein the resource includes a virtual memory.

10. The computer program product of claim 8, wherein the available capacity comprises an amount of the resource that can be committed without triggering an operation associated with overcommitting the resource.

11. The computer program product of claim 8, wherein the selecting selects the computer with the resource that is most near to the characteristic maximum requirement of the component for the resource.

12. The computer program product of claim 9, wherein the characteristic maximum virtual memory requirement of the of the component is determined based on a maximum memory utilization associated with the component for each of a series of tests performed in advance of the deploying.

13. The computer program product of claim 8, wherein the determining the characteristic maximum requirement of the component comprises:
profiling utilization of the resource in advance of the deploying;
as a result of the profiling, storing in one or more data structures a utilization, associated with the component, of the resource; and
analyzing the one or more data structures to determine a resource utilization level above which a probability of reaching that level, during a run, is less than a predetermined threshold probability.

14. A resource management system, said system comprising:
a processor; and
a memory, the memory storing instructions to cause the processor to perform:
for each of a plurality of computers, determining an available capacity associated with a resource;
selecting a computer, from the plurality of computers, having an available capacity associated with the resource that is greater than or equal to a characteristic maximum requirement of a component determined by profiling utilization of the resource; and
deploying the component on the selected computer.

15. The system of claim 14, wherein the resource includes a virtual memory.

16. The system of claim 14, wherein the available capacity comprises an amount of the resource that can be committed without triggering an operation associated with overcommitting the resource.

17. The system of claim 14, wherein the selecting selects the computer with the resource that is most near to the characteristic maximum requirement of the component for the resource.

18. The system of claim 15, wherein the characteristic maximum virtual memory requirement of the component is determined based on a maximum memory utilization associated with the component for each of a series of tests performed in advance of the deploying.

19. The system of claim 14, wherein the determining the characteristic maximum requirement of the component comprises:
profiling utilization of the resource in advance of the deploying;
as a result of the profiling, storing in one or more data structures the maximum utilization, associated with the component, of the resource; and
analyzing the one or more data structures to determine a resource utilization level above which a probability of reaching that level, during a run, is less than a predetermined threshold probability.

20. The system of claim 14, embodied in a cloud-computing environment.
